(19) United States
(12) Patent Application Publication
(10) Pub. No.: US 2011/0233010 A1
(43) Pub. Date: Sep. 29, 2011

(54) ACTUATING SYSTEM FOR A DRUM BRAKE

(76) Inventor: Olaf Drewes, Aschaffenburg (DE)

(21) Appl. No.: 13/050,569

(22) Filed: Mar. 17, 2011

(30) Foreign Application Priority Data
Mar. 25, 2010 (DE) 10 2010 003 250.6

(51) Int. Cl. F16D 51/00; F16D 51/10; F16D 51/12; F16D 51/14; B60T 1/06

(52) U.S. Cl. 188/78; 188/335

(57) ABSTRACT

An actuating system for a drum brake of a vehicle, in particular of a commercial vehicle or an agricultural machine, comprising at least a brake lining carrier (2) which is guided on a brake bracket (4), an actuating element (6; 60) in order to move the brake lining carrier (2) towards the inner circumference of a brake drum (52), and a setting means (8) in order to control the actuating element (6; 60), wherein the actuating element (6; 60) is designed as a hollow body, in the cavity (10) of which an axle body (50; 150) is accommodated.

The present invention relates to an actuating system for a drum brake of vehicles, in particular commercial vehicles or agricultural machines.

Devices of the type in question are known from the prior art. For example, from DE 40 35 943 A1 a drum brake is known, the brake lining carriers of which are held in such a way that they are pivotable on the one side and that on the other side they are moved against the inner circumferential surface of the brake drum by means of an S-shaped cam. Due to this asymmetric actuation, a problem of such brake systems is that it is not possible to ensure a balance of forces, in particular with regard to the wear on the lining, the deformation of the drum during the braking process, and influences due to the manufacturing process. Furthermore, such brake actuating systems for drum brakes are designed in a very complex manner and, in addition, due to the non-linear characteristics during the braking process, they are difficult to combine with systems for controlling the vehicle dynamics since the braking efficiency depends on the respective operating point.

Therefore, it is the object of the present invention to provide an actuating system for a drum brake of a vehicle, in particular of a commercial vehicle or an agricultural machine, which brake overcomes the above-mentioned disadvantages and which in particular can be controlled pneumatically.

This object is achieved by means of an actuating system for a drum brake of a vehicle, in particular of a commercial vehicle or an agricultural machine, having the features of claim 1 as well as by means of a drum brake system for a vehicle, in particular for a commercial vehicle or an agricultural machine, having the features of claim 10. Preferred embodiments are defined in the dependent claims.

According to the invention, there is provided an actuating system for a drum brake of a vehicle, in particular of a commercial vehicle or an agricultural machine, comprising at least a brake lining carrier or brake shoe which is guided on a brake bracket or brake support, an actuating element in order to approach or move the brake lining carrier towards the inner circumference of a brake drum, and a setting means in order to control or actuate the actuating element, wherein the actuating element is designed as a hollow body, in the cavity of which an axle body is accommodated. The actuating system for the drum brake is employed in particular in commercial vehicles or agricultural machines, such as trucks or semi-trailers drawn by such trucks, which are designed to transport heavy loads so that—unlike in passenger cars—the drum brake has to achieve a very high braking efficiency. In such vehicle systems, the brake bracket is usually securely fixed essentially to an axle body or a rigid or non-rotating axle or axle tube or axle stub so that braking torque is induced from the brake lining carrier into the brake bracket and can be induced into the vehicle frame by means of fixing or fastening on the axle body. To put it differently, the brake bracket, axle body and vehicle frame advantageously form a unit which—with regard to the wheel center—essentially cannot be rotated relative to each other. Expediently, the brake lining carrier has a brake lining on its outer surface, wherein the geometrical outer configuration of said brake lining essentially corresponds to the inner configuration of the brake drum. The brake lining carrier is guided on the brake bracket such that the brake lining carrier can approach the inner circumference or inner circumferential surface of the brake drum. This is done by means of an actuating element which can interact with the brake lining carrier or be engaged with the brake lining carrier such that the brake lining carrier is advanced towards the inner circumferential surface of the brake drum. To this end, a setting means is provided in order to control the actuating element. Thus, the setting means expediently (mechanically) engages with the actuating element such that the actuating element is set in operation when the setting means is actuated or operated or activated. It is particularly preferred that the actuating system according to the invention has two brake lining carriers which are opposite each other with respect to the longitudinal axis or axis or rotation or axis of symmetry of the axle body or with respect to the axis of rotation of the brake drum. It is also advantageous that an even number or a multiple of two brake lining carriers is provided, wherein each pair of brake lining carriers is located opposite each other. The actuating element is designed as a hollow body, in the cavity of which the axle body is accommodated. Advantageously, the actuating element can be designed as a ring-shaped or tube-shaped body which is put onto or slid onto the axle body. The inner cross-sectional configuration of the actuating element can be of any design, such as round, oval or polygonal. However, it is particularly expedient that said configuration corresponds to the geometric configuration of the axle body or an intermediate element provided between the axle body and the actuating element (such as a bearing). This makes it possible to provide a particularly compact actuating system for a drum brake.

Advantageously, the actuating element is rotatorily movable with respect to the axle body, wherein the axis of rotation of the actuating element preferably is aligned with the longitudinal axis of the axle body. To put it differently, the actuating element is rotatable or pivotable with respect to the rigid or rotatable axle body or the rotatable or rigid/stationarily arranged brake drum. Here, the axis of rotation of the actuating element expediently corresponds to the axis of rotation of the brake drum. Thus, the actuating element and the axle body as well as the brake drum are arranged concentrically to each other or have the same axis.

Preferably, the actuating element has at least a radial projection which can be made to engage with the brake lining carrier when the actuating element is actuated. Expediently, an identical number of brake lining carriers and projections are provided. To put it differently, each projection of the actuating element matches a respective brake lining carrier.

Expediently, the outer circumference of the actuating element is designed to continuously increase in the area of the projection. To put it differently, the radius of the outer circumference continuously increases in the circumferential direction in the area of the contact surface or engaging surface, respectively, between the brake lining carrier and the actuating element. Here, the increase in circumference in this area can be linear or constant. In the case of two or more projections, it is particularly advantageous that the configuration is such that said projections are designed essentially point symmetric with respect to the axis of rotation of the actuating element.

In a further preferred embodiment the actuating element is translatorily movable with respect to the axle body, wherein its axis of translation either perpendicularly intersects the longitudinal axis of the axle body or is parallel thereto. In the case of a perpendicular arrangement of the axis of translation and the longitudinal axis of the axle body, there are also provided radial projections. Similar to what has been described above, the radial extension of the projections expediently increases along the axis of translation of the actuating element. However, in this case, the projections expediently are not designed point symmetric to the axis of rotation of the actuating element, but mirror symmetric to the axis of translation of the actuating element. However, it is also possible to move the actuating element along or parallel to or coaxial to the longitudinal axis of the axle body so as to guide the brake lining carriers towards the inner circumference of the brake drum. To this end the actuating element has at least in those areas which are brought into contact with the brake lining carrier the configuration of the envelope surface of a cone.

As a matter of course, also a combination of rotatory and translatory movement of the actuating element is possible.

Advantageously, the actuating element has engaging means with which corresponding engaging means of the setting means can engage in order to control or actuate the actuating element. The engaging means of the actuating element can be designed as radially or axially oriented toothing of at least an area of the outer end surface or circumferential surface of the actuating element, for example. Accordingly, the setting means has corresponding engaging means in order to allow for a positive locking between the setting means and the actuating element.

Expediently, the engaging means of the actuating means are designed on its surface area, and the setting means preferably is designed as a shaft or pinion having outer teeth, which shaft or pinion is arranged essentially parallel to the longitudinal axis of the axle body. The engaging means of the actuating element can be designed as toothing or other surface design provided on the inner and/or outer surface area of the actuating element. When the setting means is designed as a bevel pinion, the axis of rotation of the setting means can also be arranged slanted with respect to the longitudinal axis of the axle body.

Alternatively, the engaging means of the actuating element are designed at its end face, and the setting means preferably is designed as a shaft or pinion having outer teeth, which shaft or pinion is arranged slanted, preferably essentially perpendicular, to the longitudinal axis of the axle body. A lever which is arranged essentially vertical to the axis of rotation of the setting means and attached to said setting means, thus, can be actuated by a braking cylinder arranged parallel to the longitudinal axis of the axle body. This makes it particularly advantageously possible that the braking cylinder can be integrated directly on the brake bracket without having to provide an additional accommodation for the braking cylinder on the axle body. This is particularly advantageous since the entire brake can be preassembled as a unit.

Advantageously the brake lining carrier is guided translatorily and/or rotatorily on the brake bracket. In case it is rotatorily guided, the brake lining carrier is supported on one end and pivoted towards the outside by twisting a cam shaft, which acts towards the other side and is arranged eccentrically with respect to the brake drum center. This asymmetric actuation leads to a self-energizing effect of the braking process, which, however, has not only advantages to offer. Therefore, it is particularly preferred that the brake lining carrier is guided translatorily on the brake bracket. To put it differently, the brake lining carrier is only guided movably along a straight line which extends radially from the axis of rotation of the brake drum. Thus, in a multitude of brake lining carriers said brake lining carriers are guided in pairs parallel to each other or movably along a straight line. This provides for a particularly advantageous linear output of force comparable to the performance characteristics of a disk brake, which simplifies an integration into vehicle dynamics control systems. Moreover, a more compact lining geometry compared to conventional drum brakes is made possible.

Furthermore, according to the invention there is provided a drum brake system of a vehicle, in particular of a commercial vehicle or an agricultural machine, comprising at least a brake lining carrier which is guided on a brake bracket, an actuating element in order to approach the brake lining carrier towards the inner circumference of a brake drum, a setting means in order to control the actuating element, and a pneumatically actuatable braking cylinder which is operatively connected or can be operatively connected with the setting means, wherein the actuating element is designed as a hollow body, in the cavity of which an axle body is accommodated. Expediently, the braking cylinder can be actuated pneumatically via the central compressed air supply of the vehicle. The braking cylinder is allocated to the actuating system for the drum brake such that it can act on the setting means, such as cause it to rotate. As a result, the actuating element is moved rotatorily or translatorily.

As a matter of course, further advantages and features of the actuating system for a drum brake according to the invention can also be employed in the drum brake system.

Further advantages and features of the invention result from the following description of preferred embodiments of the invention with reference to the appended Figures, wherein individual features of individual embodiments can be combined to form new embodiments. The Figures show:

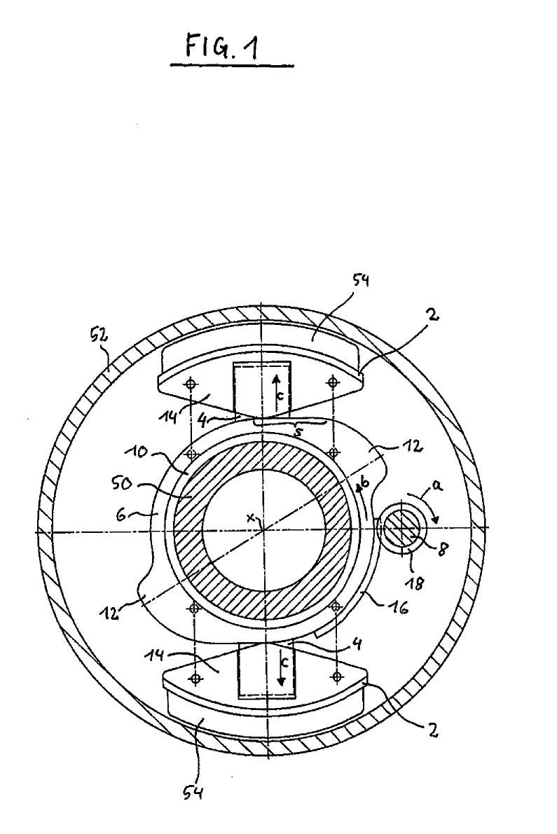

FIG. 1 a cross-sectional view of a preferred embodiment of the actuating system for a drum brake according to the invention,

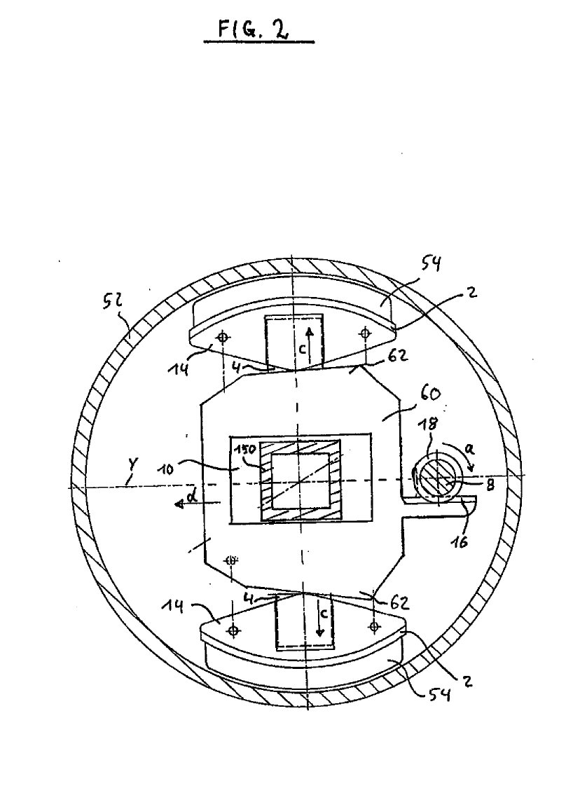

FIG. 2 a cross-sectional view of a further embodiment of the actuating system for a drum brake according to the invention,

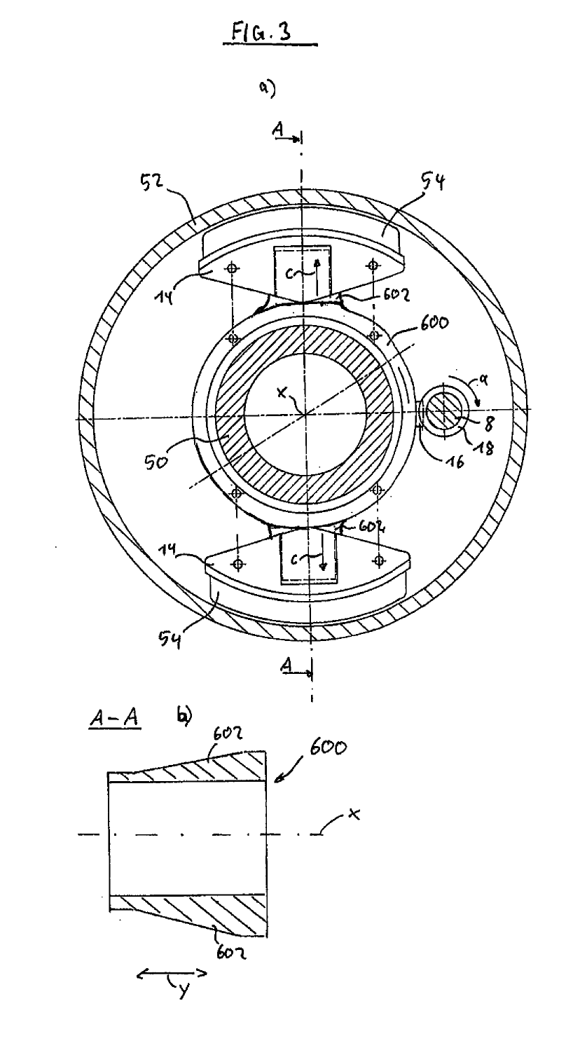

FIG. 3 a cross-sectional view of a further embodiment of the actuating system for a drum brake according to the invention.

FIG. 1 depicts a cross-sectional view of a first preferred and exemplary embodiment of an actuating system for a drum brake of a vehicle according to the invention. Said system comprises a brake lining carrier 2, a brake bracket 4, an actuating element 6 as well as a setting means 8.

The actuating means 6 is designed as a tube- or ring-shaped body which is supported on a rigid axle body 50 in a turnable or rotatable manner via bearing elements (not shown). To this end the axle body 50 extends through the cavity 10 of the actuating element 6. The actuating element 6 is rotatable around an axis of rotation x which also corresponds to the axis of rotation x of a brake drum 52 as well as the longitudinal axis of the axle body 50.

The actuating element 6 has two opposite projections 12 which are designed such that the outer circumference of the actuating element 6 increases radially in the circumferential direction in the contact area s between the brake lining carrier 2 and the actuating element 6. Particularly expediently the distance to the axis of rotation x increases linearly or constantly.

The brake lining carrier 2 has a guiding section 14 on the side opposite of the brake lining 54 by means of which the brake lining carrier 2 is guided along a radial straight line in a translatorily movable manner.

In order to control or actuate the actuating element 6 said actuating element has engaging means 16 which are designed as toothing provided on the outer circumference. Engaging means 18 of the setting means 8, which engaging means are designed as toothing, can engage with the engaging means 16.

When the setting means 8 is rotated in the arrow direction a, the actuating element 6 is rotated around its axis of rotation x in the arrow direction b due to the mutual engagement of the engaging means 16, 18. As a result, the surface of the actuating element 6 engages with the guiding section 14 of the brake lining carrier 2 in the area of the projection 12 and moves the brake lining carrier 2 in the arrow direction c so that the brake lining 54 is approached towards the inner surface area of the brake drum 52 and finally contacts the same.

FIG. 2 depicts a further preferred and exemplary embodiment of an actuating system for a drum brake according to the invention, wherein those elements which are identical to elements of FIG. 1 are denoted with identical reference numerals. The actuating element 60 has two opposite projections 62 and is supported on an axle body 150 movably along an axis of translation y. In the embodiment shown, the axle body 150 has an essentially rectangular cross-section in order to allow for a better guiding for the actuating element 60. When the setting means 8 is actuated, it is rotated in the arrow direction a so that—due to the engagement of the engaging means 16, 18—the actuating element 60 is translatorily moved in the arrow direction d along the axis of translation y. As a result, the projections 62 become engaged with the guiding sections 14 of the brake lining carriers 2 and move them in the arrow direction c towards the inner circumference of the brake drum 52.

FIG. 3 depicts a further preferred and exemplary embodiment of an actuating system for a drum brake according to the invention, wherein those elements which are identical to elements of FIGS. 1 and 2 are denoted with identical reference numerals. The actuating element 600 is designed such that its outer surface area widens at least in certain areas along its axis of rotation x in the radial direction. In particular, the actuating element 600 can have a surface area at least in certain areas, which corresponds to that of a cone (cf. FIG. 3b). As a consequence, the actuating element 600 essentially has two opposite projections 602 which increase along the axis of rotation x in the radial direction. Said projections 602 are designed to become engaged with the guiding section 14 of the brake carrier 2 when the actuating element 600 is moved along an axis of translation y which is essentially parallel to the axis of rotation x and, thus, to move the brake lining carrier 2 in the arrow direction c. As is the case in the embodiments described above, this translatory movement of the actuating element 600 is carried out via the setting means 8 which rotates in the arrow direction a, wherein due to the engagement of the engaging means 16, 18 the actuating element 600 is moved along the axis of translation y or the axis of rotation x.

### List of Reference Signs

2 brake lining carrier

4 brake bracket

6 actuating element

8 setting means

10 cavity

12 projection

14 guiding section

16 engaging means

18 engaging means

50 axle body

52 brake drum

54 brake lining

60 actuating element

62 projection

150 axle body

600 actuating element

602 projection

s contact area

x axis of rotation

y axis of translation

a, b, c, d arrow direction

1. An actuating system for a drum brake of a vehicle, in particular of a commercial vehicle or an agricultural machine, comprising
at least a brake lining carrier (2) which is guided on a brake bracket (4), an actuating element (6; 60) in order to move the brake lining carrier (2) towards the inner circumference of a brake drum (52), and
a setting means (8) in order to control the actuating element (6; 60),
wherein the actuating element (6; 60) is designed as a hollow body, in the cavity (10) of which an axle body (5; 150) is accommodated.

2. The actuating system of claim 1, wherein the actuating element (6) is rotatorily movable with respect to the axle body (50), and wherein the axis of rotation (x) of the actuating element (6) preferably is aligned with the longitudinal axis of the axle body (50).

3. The actuating system of any one of the preceding claims, wherein the actuating element (6; 60) has at least a radial projection (12; 62) which can be engaged with the brake lining carrier (2) when the actuating element (6; 60) is actuated.

4. The actuating system of claim 3, wherein the outer circumference of the actuating element (6; 60) is designed such that it continuously widens in the area of the projection (12; 62).

5. The actuating system of any one of the preceding claims, wherein the actuating element (60) is translatorily movable with respect to the axle body (150), and wherein its axis of translation (y) intersects the longitudinal axis of the axle body either perpendicularly or is designed parallel thereto.

6. The actuating system of any one of the preceding claims, wherein the actuating element (6; 60) has engaging means (16), with which corresponding engaging means (18) of the setting means (8) can engage in order to control the actuating element (6; 60).

7. The actuating system of claim 6, wherein the engaging means (16) of the actuating element (6; 60) are designed at its surface area, and the setting means (8) preferably is designed as a shaft or a pinion with outer teeth, which shaft or pinion is arranged essentially parallel to the longitudinal axis of the axle body (50; 150).

8. The actuating system of claim 6, wherein the engaging means of the actuating element (6; 60) are designed at its end face, and the setting means (8) preferably is designed as a shaft or a pinion with outer teeth, which shaft or pinion is arranged slanted, preferably perpendicular, to the longitudinal axis of the axle body.

9. The actuating system of any one of the preceding claims, wherein the brake lining carrier (2) is guided translatorily and/or rotatorily on the brake bracket (4).

10. Drum brake system of a vehicle, in particular of a commercial vehicle or an agricultural machine, comprising:
at least a brake lining carrier (2) which is guided on a brake bracket (4), an actuating element (6; 60) in order to approach the brake lining carrier (2) towards the inner circumference of a brake drum (52),
a setting means (8) in order to control the actuating element (6; 60), and a pneumatically actuatable braking cylinder which is operatively connected or can be operatively connected with the setting means (8),
wherein the actuating element (6; 60) is designed as a hollow body, in the cavity (10) of which an axle body (50; 150) is accommodated.
